(19) United States
(12) Patent Application Publication
(10) Pub. No.: US 2011/0178857 A1
(43) Pub. Date: Jul. 21, 2011

(54) Methods and Systems for Incentivizing Survey Participation

(76) Inventor: Thomas DelVecchio, New York, NY (US)

(21) Appl. No.: 13/007,436

(22) Filed: Jan. 14, 2011

Related U.S. Application Data
(60) Provisional application No. 61/295,484, filed on Jan. 15, 2010.

(51) Int. Cl. G06Q 30/00

(52) U.S. Cl. 705/14.19

(57) ABSTRACT

Systems and methods for providing survey incentives wherein participants in a first survey are permitted to access the results of the first survey, to submit additional questions used to generate a second survey, and to request managed introductions and communications with other survey participants. In at least one implementation, the method contemplates providing a survey network wherein market participants are invited to participate in surveys and provided an incentive to do so in the form receiving the results of the survey and being allowed to submit additional questions for contemporaneous or subsequent inclusion in another survey or the same survey. In a further implementation, the present invention facilitates communication between two or more survey participants as an additional incentive to complete the survey.

### CROSS REFERENCE TO RELATED APPLICATIONS

This application claims the benefit of U.S. Provisional Application No. 61/295,484, filed Jan. 15, 2010, which is incorporated herein by reference.

### BACKGROUND OF THE INVENTION

1. Field of the Invention

The present invention relates generally to conducting surveys. More particularly, the present invention relates to methods and apparatus for incentivizing survey participation by permitting survey participants to submit additional questions, based in part on an initial survey, from which a second survey is subsequently generated.

2. Background and Related Art

It is desirable for business entities to evaluate and improve the quality of the products and/or services they provide, the level of customer satisfaction with such products and/or services, and the effectiveness of market strategies in an effort to ultimately increase profitability. Directors, officers, and managers may engage in a myriad of collection techniques in an effort to capture qualitative and quantitative data regarding behaviors, opinions, attitudes, and trends in the marketplace. Such market research may be a useful step preceding the introduction of a new product, service, or market strategy to gauge how the new component will be received by the marketplace.

Currently, many different types of market research exist. One common form of market research is conducting standardized surveys. Standardized surveys typically include a multiplicity of questions spanning a range of topics with varying levels of specificity. Numerous methods exist for generating a standardized survey adapted to a given purpose, selecting an appropriate standardized survey for such a purpose, and assigning the survey to appropriate recipients.

Traditionally, one of the common obstacles limiting the effectiveness of market research strategies employing standardized surveys is encouraging widespread and consistent participation. Recipients of the standardized survey are often unwilling to take the time or employ the resources necessary to complete the survey accurately, if they complete it at all. Further, by their nature, standardized surveys often repeat common marketplace inquiries thereby reducing a recipient's incentive to carefully respond to each question over time. Even more problematic, recipients often lack an initial incentive to participate in the survey because they are rarely privy to any or all of the results. In an effort to partially overcome such obstacles, current methods provide participating recipients of the survey access to some or all of the survey results.

While conventional survey methods do provide some incentives in a wide variety of applications, conventional survey methods and associated incentives do have shortcomings. For example, standardized surveys, as the name implies, are often generic. As a result, many of the questions are often inapplicable to survey recipients. Further, even if participating recipients of the survey are given access to the survey results, the results are frequently unhelpful for the same reason. In another example, standardized surveys do not permit participating recipients to either generate their own survey or submit questions to improve the subsequent efficacy of the existing survey. Again, even if participating recipients of the survey are given access to the survey results, the results are frequently unhelpful as a result.

Thus, while techniques currently exist that are used to incentivize survey participation, challenges still exist, including those previously mentioned. Accordingly, it would be an improvement in the art to augment or even replace current techniques with other techniques.

### BRIEF SUMMARY OF THE INVENTION

The present invention relates generally to conducting surveys. More particularly, the present invention provides a method and apparatus for incentivizing survey participation by permitting survey participants to submit additional questions, based in part on an initial survey, from which a second survey is subsequently generated.

Implementation of the present invention takes place in association with survey incentives wherein participants in a first survey are permitted to access the results of the first survey, to submit additional questions used to generate a second survey, and to request managed introductions and communications with other survey participants. In at least one implementation, a method for incentivizing survey participation includes providing a survey network; inviting market participants to join the survey network; and allowing the market participants to submit questions and define a group of members of the survey network, based on various attributes, to receive a survey containing their questions. A survey is subsequently generated, based on the questions, and distributed to the defined group and the defined group is invited to participate in the survey. In such implementations, the defined group is incentivized to participate in the survey by being permitted to receive the results of the survey after they are collected and being permitted to submit additional questions and define other groups of network members to receive a survey containing their questions. Another survey is subsequently generated, based on the additional questions, and distributed to the other defined groups who are also invited to participate in the survey. In such implementations, both of the surveys discussed are subsequently completed and collected. The raw data is then aggregated, processed, analyzed and distributed to all participating members of the survey network.

Both the survey network members and the market participants, in some implementations, may be end-users. Alternatively, in other implementations, both the survey network members and the market participants may be other business entities.

The market participant may, in some implementations, be permitted to generate an entire survey and submit it unchanged to the entire survey network or select groups within the network as discussed above. Alternatively, the market participant may generate all or part of a survey and submit it to the entire survey network subject to subsequent changes by other network members and/or survey recipients.

In some implementations, the steps of the present method may be repeated an unlimited number of times whereby numerous surveys can be generated and distributed. Further, in some implementations, individual surveys can continuously be updated by survey participants whereby a survey is continually modified and repeatedly distributed to generate an ongoing survey based dialogue. For instance, peer business entities or end-users could continually circulate a given survey following the steps outlined above to perpetually engage in posing questions and submitting responses to ongoing marketplace problems or concerns. Alternatively, in some implementations, a given survey may be distributed as little as a single time for any number of reasons. In such implementations, the usefulness of the survey may simply expire due to changes in marketplace conditions.

In addition to the features of the present invention discussed above, in some implementations, participants in a first survey are permitted to request managed introductions and communications with other survey participants. In such implementations, the two network members may subsequently communicate directly with one another without employing the survey system and method.

In addition to the aforementioned components and characteristics, the method adapted to incentivize survey participation can be implemented in any suitable manner. For example, in at least one implementation, a system for incentivizing survey participation over a survey network includes a database for storing multiple network members and associated attributes; another database for storing multiple surveys; and a server in communication with both databases and the survey network adapted to execute each of the components and characteristics of the method discussed above.

While the methods and processes of the present invention have proven to be particularly useful in the area of incentivizing survey participation, those skilled in the art can appreciate that the methods and processes can be used in a variety of different applications and in a variety of different industries to yield broad industry-based or community-based participation.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE SEVERAL VIEWS OF THE DRAWINGS

In order that the manner in which the above recited and other features and advantages of the present invention are obtained, a more particular description of the invention will be rendered by reference to specific embodiments thereof, which are illustrated in the appended drawings. Understanding that these drawings depict only typical embodiments of the present invention and are not, therefore, to be considered as limiting the scope of the invention, the present invention will be described and explained with additional specificity and detail through the use of the accompanying drawings in which:

FIG. 1 shows a representative system for use with embodiments of the invention;

FIG. 2 shows a representative network system for use with embodiments of the invention;

FIG. 3 is a flow diagram that illustrates an example of a sequence that may be used for incentivizing survey participation;

FIG. 4 is a flow diagram that illustrates an example of a sequence that may be used for generating a survey based on questions submitted by market participants;

FIG. 5 is a flow diagram that illustrates an example of a sequence that may be used for collecting and handling survey data;

FIG. 6 is a flow diagram that illustrates an example of a sequence that may be used for defining a select group of members of the survey network;

FIG. 7 is a flow diagram that illustrates an example of a sequence that may be used for further defining a select group of members of the survey network;

FIG. 8 is a flow diagram that illustrates an example of a sequence that may be used for distributing surveys to survey recipients and saving the survey responses;

FIG. 9 is a flow diagram that illustrates an example of a sequence that may be used for monitoring survey completion and distributing survey results to survey participants; and

FIG. 10 is a flow diagram that illustrates an example of a sequence that may be used for facilitating communication between two or more survey recipients.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

The present invention relates generally to conducting surveys. In particular, the present invention provides a method and apparatus for incentivizing survey participation by permitting survey participants to submit additional questions, based in part on an initial survey, from which a second survey is subsequently generated.

Embodiments of the present invention take place in association with survey incentives wherein participants in a first survey are permitted to access the results of the first survey, to submit additional questions used to generate a second survey, and to request managed introductions and communications with other survey participants. In at least one embodiment, a method for incentivizing survey participation includes providing a survey network; inviting market participants to join the survey network; and allowing the market participants to submit questions and define a group of members of the survey network, based on various attributes, to receive a survey containing their questions. A survey is subsequently generated, based on the questions, and distributed to the defined group and the defined group is invited to participate in the survey. In such embodiments, the defined group is incentivized to participate in the survey by being permitted to receive the results of the survey after they are collected and being permitted to submit additional questions and define other groups of network members to receive a survey containing their questions. Another survey is subsequently generated, based on the additional questions, and distributed to the other defined groups who are also invited to participate in the survey. In such embodiments, both of the surveys discussed are subsequently completed and collected. The raw data is then aggregated, processed, analyzed and distributed to all participating members of the survey network.

In some embodiments, both the survey network members and the market participants may be end-users. Alternatively, in other embodiments, both the survey network members and the market participants may be other business entities.

The market participant may, in some embodiments, be permitted to generate an entire survey and submit it unchanged to the entire survey network or select groups within the network as discussed above. Alternatively, the market participant may generate all or part of a survey and submit it to the entire survey network subject to subsequent changes by other network members and/or survey recipients.

In some embodiments, the steps of the present method may be repeated an unlimited number of times whereby numerous surveys can be generated and distributed. Further, in some implementations, individual surveys can continuously be updated by survey participants whereby a survey is continually modified and repeatedly distributed to generate an ongoing survey based dialogue. For instance, peer business entities or end-users could continually circulate a given survey following the steps outlined above to perpetually engage in posing questions and submitting responses to ongoing marketplace problems or concerns. Alternatively, in some embodiments, a given survey may be distributed as little as a single time for any number of reasons. In such embodiments, the usefulness of the survey may simply expire due to changes in marketplace conditions.

In addition to the features of the present invention discussed above, in some embodiments, participants in a first survey are permitted to request managed introductions and communications with other survey participants. In such embodiments, the two network members may subsequently communicate directly with one another without employing the survey system and method.

In addition to the aforementioned components and characteristics, the method adapted to incentivize survey participation can be implemented in any suitable manner. For example, in at least one embodiment, a system for incentivizing survey participation over a survey network includes a database for storing multiple network members and associated attributes; another database for storing multiple surveys; and a server in communication with both databases and the survey network adapted to execute each of the components and characteristics of the method discussed above.

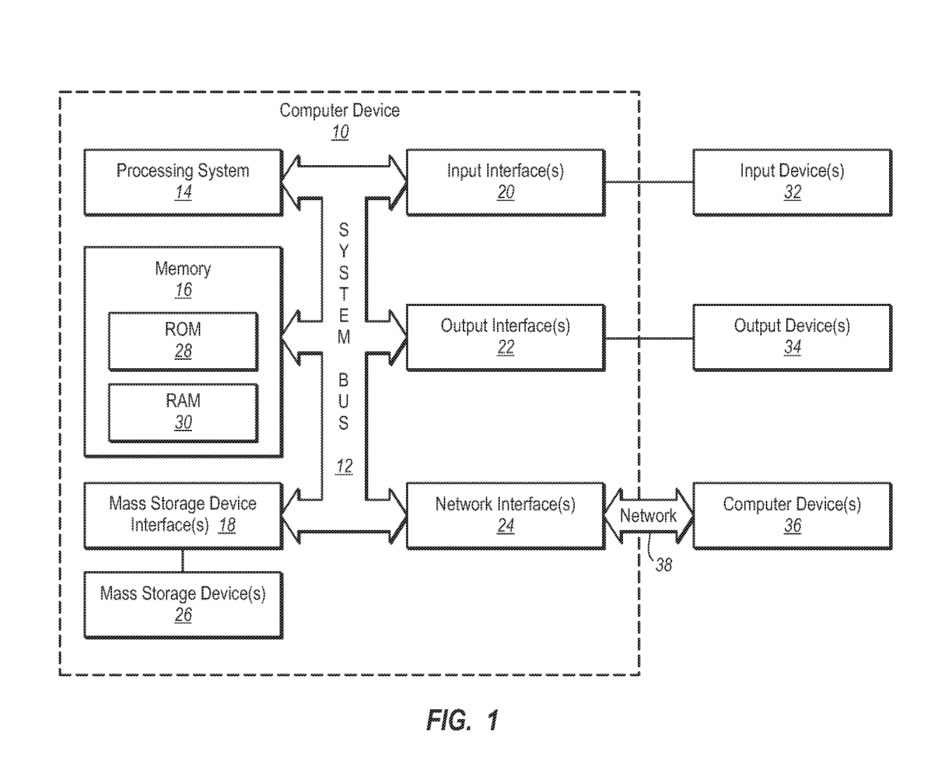

Turning to the figures, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference now to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.) that performs multi-colorant rendering. In another embodiment, the system configuration includes one or more client computer devices, optionally one or more server computer devices, and a connection or network communication that enables the exchange of communication to an output device, which is configured to perform multi-colorant rendering.

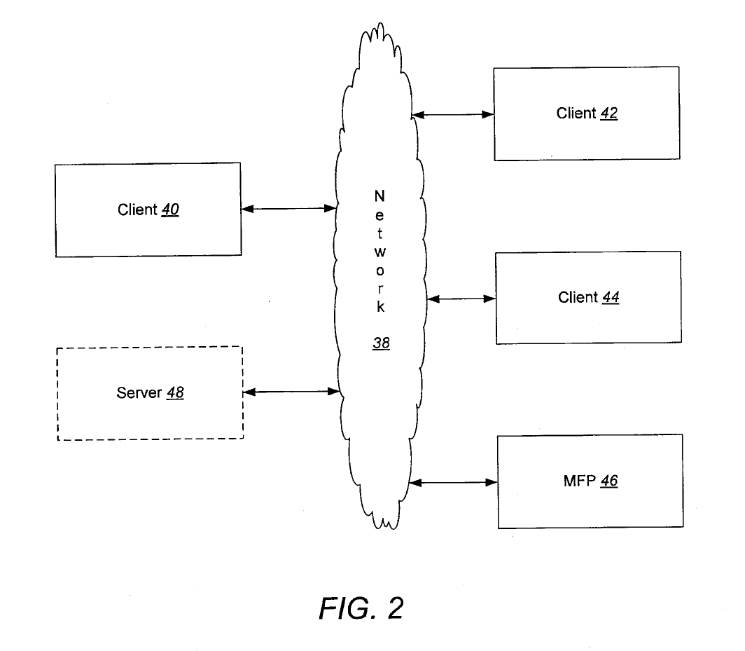

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

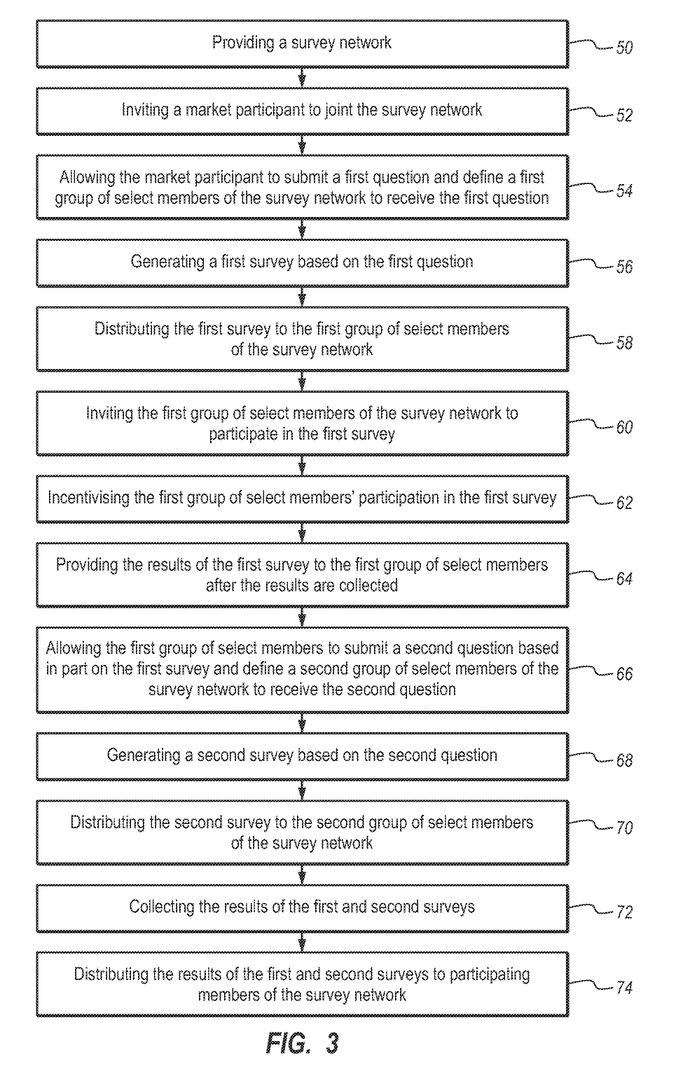

Referring now to FIG. 3, a flow diagram for incentivizing survey participation in accordance with some embodiments of the present invention is provided. At block 50, a survey network is provided. In some embodiments, the survey network may be implemented by means of the representative system discussed with reference to FIG. 1 above and/or by means of the representative network system discussed with reference to FIG. 2 above. In other embodiments, the survey network may be implemented by other suitable means. For example, the survey network may be implemented by one or more people who share work space or labor in separate locations. In such embodiments, the survey network may consist of face-to-face, telephonic, written or other forms of interaction in association with survey files.

At block 52, market participants are invited to join the survey network previously provided at block 50. In various embodiments, market participants may be invited to join the survey network at block 50 via mail, telephone, email, text-message, in-person contact, at retail locations, over the internet by means of a website including but not limited to use of online banner ads, embedded Uniform Resource Locators (URLs), pop-up browser windows or other forms of online invitations. Likewise, in various embodiments, market participants may include end-users, business entities, non-profit organizations, governmental organizations, consumers, retailers, manufacturers, distributors, and the like.

At block 54, market participants, as discussed with reference to block 52 above, are allowed to submit questions within the survey network for inclusion in one or more surveys. In some embodiments, an individual market participant may submit only a single question or may submit either a limited or an unlimited number of questions to be included in one or more of a variety of surveys. In other embodiments, multiple market participants may combine their efforts through the survey network to submit a mutually beneficial question or set of questions.

In some embodiments, market participants, either independently or in concert, may submit an entire survey in completed form. However, as mentioned above, some embodiments contemplate submission of only a single question. Questions will typically be submitted in survey format but need not be. Where questions are submitted in an alternative format, the survey network and/or associated administrators may modify either the substance or the format of the question such that it is consistent with other questions in the survey within which it is ultimately included.

In addition, in some embodiments, questions may be submitted by market participants for inclusion in upcoming surveys. In such embodiments, market participants could be notified about the general nature or topic of a proposed survey before hand and given a set period of time in which to craft and submit a relevant question to be included in the survey. Such notifications could be accomplished through some or all of the channels used to initially invite the market participants to join the survey network as discussed above with reference to block 52. In other embodiments, however, questions may be submitted by market participants for inclusion in older or previously existing surveys which can then be re-circulated with the additional question as appropriate. In still other embodiments, questions may be submitted for surveys currently in circulation. In such embodiments, the additional questions can be distributed as an addendum to the survey for participants who have already completed the survey or incorporated into the survey for participants who have yet to complete the survey.

In some embodiments, still with reference to block 54 of FIG. 3, market participants are permitted to define a group of select members of the survey network to receive a survey containing the questions previously submitted as discussed above. In such embodiments, a pool of survey participants is created. In some embodiments, the pool may include all members of the entire survey network. In other embodiments, the pool of survey takers is only a portion of the whole survey network selected according to various network member attributes. In such embodiments, network member attributes may be used as a filter in the network member selection process whereby a reduced segment or portion of network members is identified for receipt of a given survey.

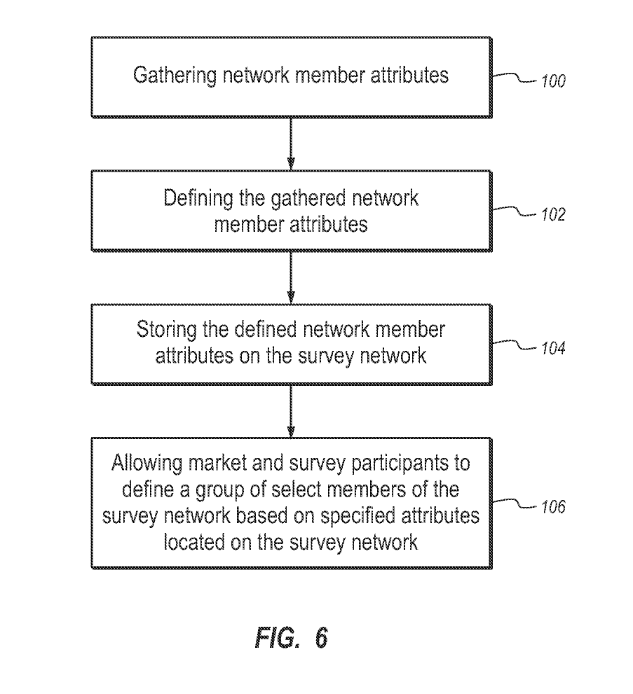

With further reference now to FIG. 6, a flow diagram for defining select members of the survey network in accordance with some embodiments of the present invention is provided. In block 100, network member attributes are gathered into the survey network and stored accordingly. In various embodiments, network member attributes may be gathered at block 100 via mail, telephone, email, text-message, in-person contact, at retail locations, over the internet by means of a website including but not limited to use of online banner ads, embedded Uniform Resource Locators (URLs), pop-up browser windows or other forms of online data gathering.

At block 102, the gathered network member attributes can be defined and classified such that various attributes are searchable according to specified categories, classes, sub-classes and the like. In such embodiments, some non-limiting examples of defined attributes may include titles, employee count, organization size, annual revenue statistics, geographic locations, industry, products, services, market strategies, organizational structure, public or private status, longevity, funding, subsidiary relationships, estimated value, and so forth. At block 104, the gathered network members attributes may be stored as mentioned above by any of the storage methods and systems previously discussed.

At block 106, market and survey participants alike are allowed to define a group of select members of the survey network (i.e. a sub-sample) according to specified attributes as discussed above. In such embodiments, market and survey participants are able to create a sub-sample of survey recipients by selecting the appropriate attributes or establishing other related criteria that will screen all potential research sample members whereby those that do not possess the necessary attributes or do not fall within the appropriate criteria are filtered out. The sub-sample is then populated with the survey candidates that fit the selected criteria or have the specified attributes. In such embodiments, the sub-sample members are then flagged for receipt of an associated survey. In some embodiments, multiple sub-sample groups may be generated based on any combination of attributes and/or selected criteria simultaneously. Alternatively, sub-sample groups may be created one at a time. In further embodiments of the present invention, market and survey participants are allowed to define a group of select members of the survey network according to specified attributes repeatedly whereby numerous sub-sample groups can be generated.

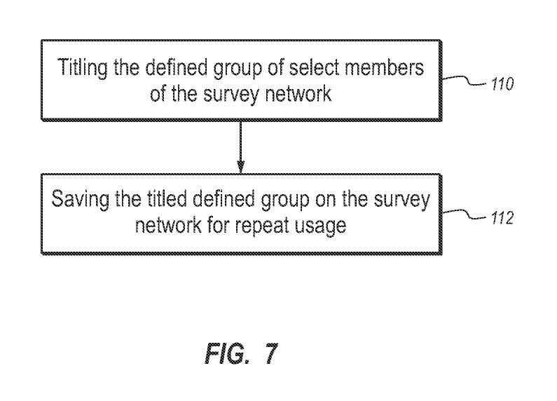

Referring now to FIG. 7, a flow diagram for organizing sub-sample groups and storing them on the survey network in accordance with some embodiments of the present invention is provided. At block 110, the sub-sample, or select group of network members, can be given a title by which the sub-sample can be identified for future use. At block 112, the title may then be saved in association with the sub-sample that was generated such that the sub-sample may be selected for repeat future usage such as sending surveys and survey results or related purposes.

In various embodiments, groups of select members of the survey network may include, market participants including end-users, business entities, non-profit organizations, governmental organizations, consumers, retailers, manufacturers, distributors, and the like.

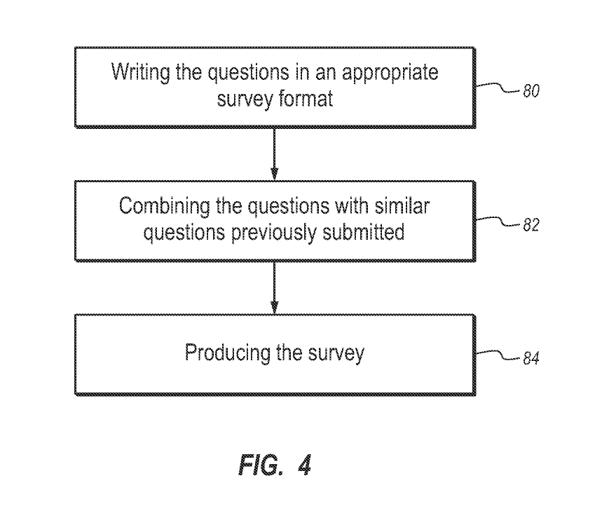

Turning briefly back to FIG. 3, at block 56 an initial survey is generated based on the questions submitted by market participants as discussed previously. With reference now to FIG. 4, a flow diagram for generating the initial survey based on questions submitted by market participants in accordance with some embodiments of the present invention is provided. At block 80, the submitted questions are recast in an appropriate format which may vary depending on the specific survey into which it will ultimately be incorporated. In other embodiments, the questions will typically already be in a suitable format when submitted.

At block 82, the submitted question or questions is/are combined with other similar questions submitted by other market participants. Again, as discussed relative to block 80, the submitted questions may be recast such that they are cohesive with the other questions ultimately included in the survey. However, in some embodiments, the questions will typically already be consistent with the overall survey when submitted. For example, in some embodiments multiple questions may be submitted by a single user or a group of users as discussed with reference to block 54 of FIG. 3 such that the questions constitute a complete survey when submitted. At block 84, the survey incorporating various market participant generated questions is produced. The survey may contain any number or combination of questions including multiple choice questions, checkbox questions, open-ended commentary fields, or scale type questions such as asking users to indicate how strongly the agree or disagree with a given statement and so forth.

Turning briefly back to FIG. 3, at block 58 the initial survey generated with reference to block 56 is distributed to a sub-sample or a first group of select members of the survey network defined with reference to block 54. In some embodiments, distributing the initial survey may be accomplished by mail, telephone, facsimile, email, text-message, in person, at retail locations, over the internet by means of a website including but not limited to use of online banner ads, embedded Uniform Resource Locators (URLs), pop-up browser windows or other forms of online distribution, or over the internet via Really Simple Syndication (RSS) feed.

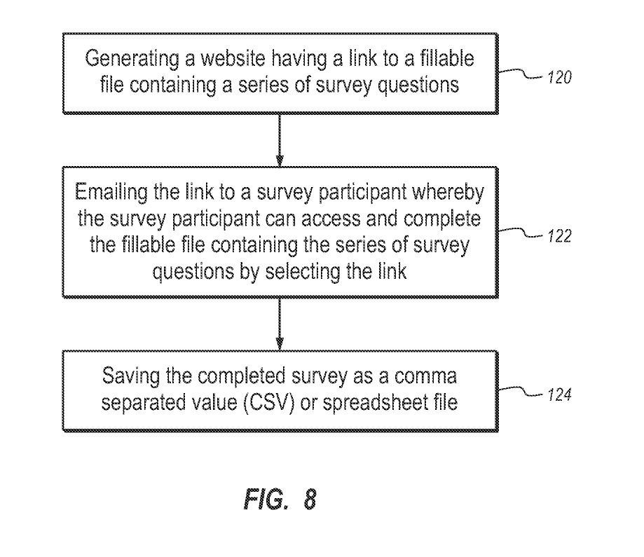

With reference now to FIG. 8, a flow diagram for an alternative method of distributing surveys to survey recipients and saving and/or cataloging corresponding responses in accordance with some embodiments of the present invention is provided. At block 120, a website is generated which incorporates an embedded URL or “link” associated with the survey network. The link directs the user to a specific survey. In some embodiments, the survey may be in a fillable Portable Document Format (PDF) that can be completed and submitted online. In other embodiments, the survey may be a fillable web-based file that similarly can be completed and submitted online. In still other embodiments, the survey may be downloaded, completed and submitted by email or facsimile. In yet another embodiment, the survey may be downloaded, completed and submitted by mail or hand delivery.

At block 122, an email containing the link is subsequently sent to a selected survey candidate or participant whereby the participant can access and complete the fillable file containing the survey by selecting the link. Following completion, the survey can be submitted as discussed above. At block 124, the file is saved and the associated responses are stored as a comma separated value (CSV) or spreadsheet file. The spreadsheet file can then be employed to order the responses in a suitable manner.

Turning back to FIG. 3, following distribution of an initial survey as discussed above, at block 60 the sub-sample group of survey candidates previously selected is then invited to complete the initial survey. In various embodiments, select survey candidates may be invited to complete the initial survey at block 60 via mail, telephone, email, text-message, in-person contact, at retail locations, over the internet by means of a website including but not limited to use of online banner ads, embedded Uniform Resource Locators (URLs), pop-up browser windows or other forms of online invitations.

At block 62, the sub-sample group is provided with various incentives to induce participation in the survey. In some embodiments, illustrated at block 64, the sub-sample group is to be provided access to the results of the initial survey after the results have been collected as an incentive to participate in the survey. In other embodiments, illustrated at block 66, a further incentive is provided. At block 66, the sub-sample or select members of the survey network are allowed to submit additional questions following participation in the initial survey. In such embodiments, the additional questions may be based in part on the substance or questions of the initial survey. In other embodiments, the questions may be wholly unrelated to the initial survey.

With reference to block 66, the submission of questions following completion of the initial survey is provided as an incentive to participate in the survey. The ability to submit additional questions provides the survey participant with several advantages. Some non-limiting examples may includes the ability to ask follow-up questions to inquires contained in the initial survey, the opportunity to generate wholly new surveys based on information collected in the initial survey, and so forth.

Still with reference to block 66, the submission of questions by survey participants for inclusion in one or more subsequent surveys operates substantially as described above with reference to block 54. Similarly, also with reference to block 66, survey participants are also allowed to define an additional group of select members of the survey network to receive a survey containing their questions. Again, this process operates substantially as described above also with reference to block 54. Survey participants may define as few as one additional group for participation in the survey or they may define a limited or an unlimited number of additional groups.

Turning to blocks 68 and 70, the steps of generating an additional survey and distributing the survey to the additional groups identified in block 66 operate substantially as described above with reference to blocks 56 and 58.

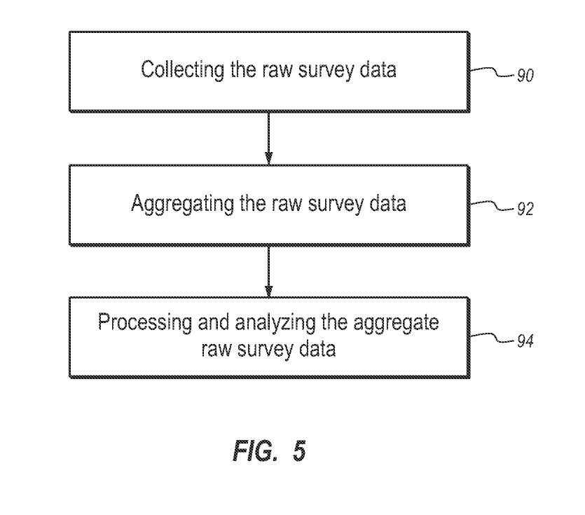

At block 72, the results of the initial survey and various subsequent surveys are collected after completion. Surveys may be ready for collection at varying times due to topic, size, sub-sample pool and so forth. Turning now to FIG. 5, a flow diagram for a method for collecting and handling survey data in accordance with some embodiments of the present invention is provided. At block 90, the raw survey responses are collected. At block 92, the survey data is aggregated to provide a meaningful statistical sample. Finally, the aggregated survey data is processed and analyzed whereby useful information can be obtained for network members. In some non-limiting examples, the raw data could be converted into graphs and/or charts indicating various market trends based on survey responses. The survey data can be used in numerous additional ways to provide network members with actionable information about the marketplace and market conditions.

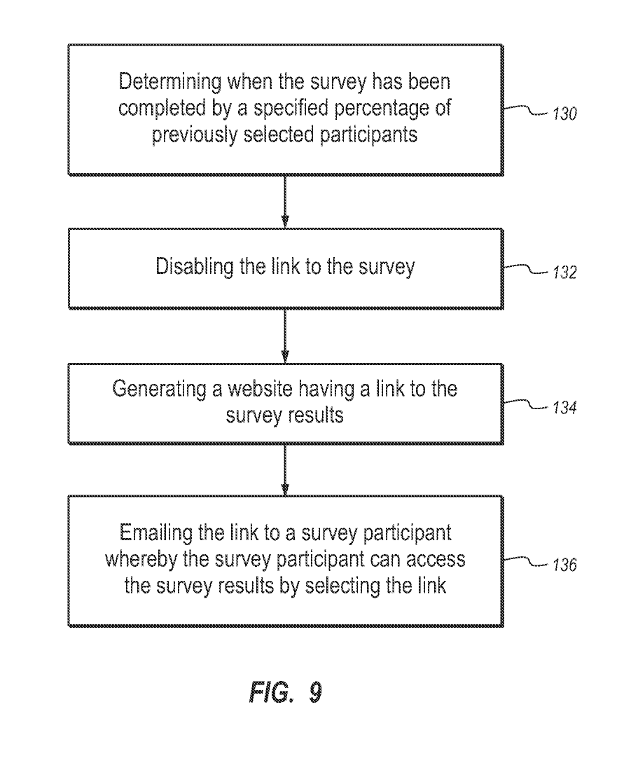

Turning now to FIG. 9, a flow diagram for a method of monitoring survey completion and distributing survey results in accordance with some embodiments of the present invention is provided. As discussed above, survey participants are provided access to the survey results as an incentive to participate in the survey once the results are collected. At block 130, it is determined when a given survey has been completed such that the results are ready for collection. In some embodiments, this may occur when a specified percentage of previously selected survey candidates have completed the survey. In other embodiments, this may occur after a set period of time. In still other embodiments, the survey may be deemed complete when a specific number of recipients have completed the survey. At block 132, when the survey has been completed, the link discussed with reference to FIG. 8 may be disabled. At block 134, a website is generated which incorporates a new embedded URL or link associated with the survey results. The link directs the user to the results for a specific survey or a group of surveys. The survey results can be in various forms including spreadsheets, graphs, charts, word-processing documents, PDF documents and the like.

At block 136 an email containing the link is subsequently sent to a selected survey candidate or participant whereby the participant can access the survey results by selecting the link.

In some embodiments, turning briefly back to FIG. 3 at block 74, the survey results may be distributed by mail, telephone, facsimile, email, text-message, in person, at retail locations, over the internet by means of a website, or over the internet via Really Simple Syndication (RSS) feed. Regardless of the method used to distribute the results, in some embodiments, the results of the survey may be distributed in raw form such that recipients can organize, classify, and analyze the raw data in a manner suitable to their needs. In alternative embodiments, the results are processed and analyzed, as discussed with reference to FIG. 5 above, prior to distribution.

In some embodiments, the entire process of the present invention illustrated in the various figures and discussed above may be repeated numerous times to generate an ongoing survey dialogue. For example, peer business entities or end-users could continually circulate a given survey following the steps outlined above to perpetually engage in posing questions and submitting responses to ongoing marketplace problems or concerns. Alternatively, in some embodiments, a given survey may be distributed as little as a single time for any number of reasons. In such embodiments, the usefulness of the survey may simply expire due to changes in marketplace conditions.

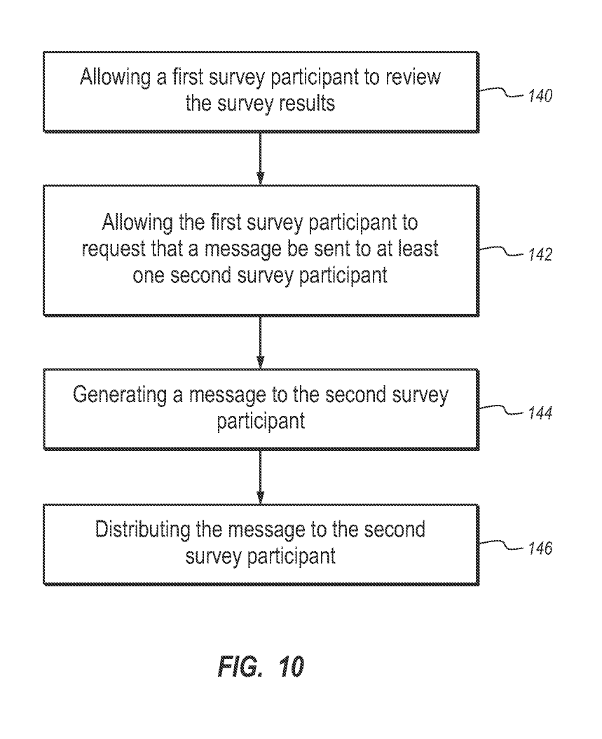

In some embodiments, an additional incentive to participate in the surveys is contemplated by the present invention. With reference now to FIG. 10, a flow diagram for a method of facilitating communication between two or more survey participants in accordance with some embodiments of the present invention is provided. At block 140, a survey participant is allowed to review and examine the survey results as discussed above. At block 142, the survey participant is then allowed to request that a message be sent to at least one additional survey participant or other network member. The survey network and/or associated administrators then generate a message and distribute it to the specified recipient. In this manner, survey participants may receive managed introductions and communications with other survey participants. In such embodiments, the two network members or survey participants may subsequently communicate directly with one another without employing the survey system and method. In some embodiments, the present invention may be employed to facilitate business-to-business introductions and communication. In alternative embodiments, end-users may be connected to other end-users or businesses may be connected to end-users and so forth.

Thus, as described herein, embodiments of the present invention embrace survey methods. More particularly, the present invention provides a method and apparatus for incentivizing survey participation by permitting survey participants to submit additional questions, based in part on an initial survey, from which a second survey is subsequently generated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A method for incentivizing survey participation comprising the steps of:
providing a survey network;
inviting a market participant to join the survey network;
generating a first survey based on a first question;
distributing the first survey to members of the survey network;
incentivizing the members' participation in the first survey comprising the steps of:
allowing members to submit a second question;
generating a second survey based on the second question; and
distributing the second survey to members of the survey network;
collecting the results of the first and second surveys; and
distributing the results of the first and second surveys to participating members of the survey network.

2. The method of claim 1, further comprising the step of allowing the market participant to submit a first question and define a first group of select members of the survey network to receive the first question.

3. The method of claim 1, further comprising the step of distributing the first survey to the first group of select members of the survey network.

4. The method of claim 1, further comprising inviting a first group of select members of the survey network to participate in the first survey.

5. The method of claim 1, wherein the step of incentivizing the members further comprises providing the results of the first survey to a first group of select members after the results are collected.

6. The method of claim 1, wherein the step of incentivizing members further comprises allowing members to define a second group of select members of the survey network to receive the second question.

7. The method of claim 1, further comprising the step of allowing members to submit a second question based in part on the first survey.

8. The method of claim 1, wherein the first and second groups of select members of the survey network are end-users.

9. The method of claim 1, wherein the first and second groups of select members of the survey network are other business entities.

10. The method of claim 1, wherein the market participant are selected from a list consisting of an end-user and another business entity.

11. The method of claim 1, wherein the steps of generating the first and second surveys based on the first and second questions further comprises the steps of:
writing the questions in an appropriate survey format;
combining the question with similar questions previously submitted; and
producing the survey.

12. The method of claim 1, wherein the steps of distributing the first and second surveys is accomplished by mail, telephone, facsimile, email, text-message, in-person, at retail locations, over the internet by means of a website, over the internet via Really Simple Syndication (RSS).

13. The method of claim 1, wherein the step of collecting the results of the first and second surveys further comprises the steps of:
collecting the raw survey data;
aggregating the raw survey data; and
processing and analyzing the aggregated survey data.

14. The method of claim 13, wherein the step of distributing the results of the first and second surveys to participating members of the survey further comprises the step of generating a report based on the processed and analyzed aggregate data.

15. The method of claim 1, wherein the market participant is allowed to generate a first survey independently and submit it to the survey network.

16. The method of claim 1, wherein the steps of defining a first and second group of select members of the survey network comprises the steps of:
gathering network member attributes;
defining the gathered network member attributes;
storing the defined network member attributes on the survey network; and
allowing market and survey participants to define a group of select members of the survey network based on specified attributes located on the survey network.

17. The method of claim 16, further comprising the steps of:
titling the defined group of select members of the survey network; and
saving the titled defined group on the survey network for repeat usage.

18. The method of claim 1, wherein the steps starting with inviting a market participant to join the survey network and continuing through the remaining steps of the method are repeated a plurality of times whereby the process generates an ongoing survey dialogue.

19. The method of claim 18, wherein the steps of allowing market and survey participants to define a group of select members, titling the defined group, and saving the titled defined group may be repeated a plurality of times to generate a plurality of saved titled defined groups on the survey network.

20. The method of claim 1, wherein the produced survey includes multiple choice answers and open-ended commentary fields.

21. The method of claim 1, wherein the steps of distributing the first and second surveys further comprises the steps of:
generating a website having a link to a fillable file containing a series of survey questions; and
emailing the link to a survey participant whereby the survey participant can access and complete the fillable file containing the series of survey questions by selecting the link.

22. The method of claim 21, wherein the completed fillable file containing the series of survey questions is saved as a comma separated value (CSV) file containing responses to the survey questions.

23. The method of claim 21, further comprising the step of:
determining when the survey has been completed by a specified percentage of previously selected recipients;
disabling the link to the survey;
generating a website having a link to the survey results; and
emailing the link to a survey participant whereby the survey participant can access the survey results by selecting the link.

24. The method of claim 23, further comprising the steps of:
allowing a first survey participant to review the survey results;
allowing the first survey participant to request that a message be sent to at least one second survey participant;
generating a message to the second survey participant; and
distributing the message to the second survey participant.

25. A system for incentivizing survey participation comprising:
a survey network;
a market participant invited to join the survey network;
a first survey based on a first question distributed to members of the survey network;
an incentivizing system structured to incentives the members' participation in the first survey comprising:
a second question submitted by a market participant;
a second survey based on the second question distributed to members of the survey network; and
a collection system structured to collect the results of the first and second surveys; and
a distribution system for distributing the results of the first and second surveys to participating members of the survey network.

26. The system of claim 25, wherein the market participant submits a first question and defines a first group of select members of the survey network to receive the first question.

27. The system of claim 25, wherein a first group of select members of the survey network are invited to participate in the first survey.

28. The system of claim 25, wherein the incentivizing system is structured to provide the results of the first survey to a first group of select members after the results are collected.

29. The system of claim 25, wherein the incentivizing system is structured to allow members to define a second group of select members of the survey network to receive the second question.

30. The system of claim 25, wherein the market participant is allowed to generate a first survey independently and submit it to the survey network.

31. The system of claim 25, wherein the defining a first and second group of select members of the survey network comprises the steps of:
gathering network member attributes;
defining the gathered network member attributes;
storing the defined network member attributes on the survey network; and
allowing market and survey participants to define a group of select members of the survey network based on specified attributes located on the survey network.

32. A system for incentivizing survey participation over a survey network comprising:
a first database comprising a plurality of network members and associated attributes;
a second database comprising a plurality of surveys; and
a server in communication with the first database, the second database and a survey network, the server configured to perform the steps of:
inviting a market participant to join the survey network;
receiving a first question and a defined first group of select members of the survey network from the market participant;
generating a first survey based on the first question;
distributing the first survey to the first group of select members of the survey network;
inviting the first group of select members of the survey network to participate in the first survey;
incentivizing the first group of select members' participation in the first survey by performing the steps of:
providing results of the first survey to the first group of select members after the results are collected;
receiving a second question and a defined second group of select members of the survey network from the first group of select members;
generating a second survey based on the second question; and
distributing the second survey to the second group of select members of the survey network;
collecting the results of the first and second surveys; and
distributing the results of the first and second surveys to participating members of the survey network.

33. A computer program product for implementing within a computer system a method for incentivizing survey participation, the computer program product comprising:
a computer readable medium for providing computer program code means utilized to implement the method, wherein the computer program code means is comprised of executable code for implementing the steps for:
providing a survey network;
inviting a market participant to join the survey network;
generating a first survey based on a first question;
distributing the first survey to members of the survey network;
incentivizing the members' participation in the first survey comprising the steps of:
allowing members to submit a second question;
generating a second survey based on the second question; and
distributing the second survey to members of the survey network;
collecting the results of the first and second surveys; and
distributing the results of the first and second surveys to participating members of the survey network.
